(19) United States
(12) Patent Application Publication
(10) Pub. No.: US 2020/0327720 A1
(43) Pub. Date: Oct. 15, 2020

(54) 2D IMAGE CONSTRUCTION USING 3D DATA

(71) Applicant: Konica Minolta Business Solutions U.S.A., Inc., Ramsey, NJ (US)

(72) Inventors: Junchao WEI, San Mateo, CA (US); Xiaonong ZHAN, Foster City, CA (US)

(21) Appl. No.: 16/383,505

(22) Filed: Apr. 12, 2019

(51) Int. Cl. G06T 15/08; G06T 17/20

(52) U.S. Cl. CPC G06T 15/08; G06T 2215/06; G06T 17/20

(57) ABSTRACT

A 2D image is constructed from constituent 2D images that show different views of the same object. Construction is performed by taking image tiles, referred to as tonal triangles, from the constituent 2D images and combining them using 3D data for the object. The 3D data define a wireframe model comprising triangles, called contour triangles. Two tonal triangles are combined based on neighbor relationships between the contour triangles that correspond to those two tonal triangles. Additional tonal triangles may be combined as desired, until the 2D constructed image is of a size that shows the subject of interest. Compared to conventional processes for stitching and montaging, the process generates a 2D constructed image that is a more accurate presentation of the true area, shape, and/or size of the subject.

### FIELD

This disclosure relates generally to image processing and, more particularly, to generating a 2D image using 3D data.

### BACKGROUND

Conventional processes for stitching or montaging photographic images often attempt to identify shared features or markers that appear in the images to determine how to combine them. These processes often fail for various reasons. For example, there may be an insufficient number of shared features found in the images. Failure may also be caused by a significant difference in the viewing angle of the images, as may occur when trying to capture features on a curved object. For example, a feature of interest may wrap around a corner or sharp bend, which requires the camera to move along a complex trajectory. Conventional processes may attempt to compensate for differences in viewing direction by applying transformation functions to the images, but transformation functions (particularly linear transformation functions that move rigidly) may cause significant warping that appears unnatural or may produce garbled results. Even when a resulting montage image appears aesthetically acceptable, the montage image may be an inaccurate representation of the true area, shape, and size of the subject. Accordingly, there is a continuing need for a method and system for montaging images capable of addressing the issues discussed above and others.

### SUMMARY

Briefly and in general terms, the present invention is directed to a method and a system for generating a 2D constructed image.

In aspects of the invention, a method comprises receiving tonal data for 2D images all showing an object in common. The method comprises receiving depth data for the object, the depth data defining a plurality of contour triangles that model surface contours of the object, each contour triangle having three vertices in 3D space, the plurality of contour triangles corresponding to a plurality of tonal triangles in the 2D images. The method comprises generating the 2D constructed image by combining the tonal triangles taken from the 2D images based on neighbor relationships among the plurality of contour triangles.

In aspects of the invention, a system comprises a processor and a memory in communication with the processor, the memory storing instructions. The processor is configured to perform a process according to the stored instructions. The process comprises receiving tonal data for 2D images all showing an object in common. The process comprises receiving depth data for the object, the depth data defining a plurality of contour triangles that model surface contours of the object, each contour triangle having three vertices in 3D space, the plurality of contour triangles corresponding to a plurality of tonal triangles in the 2D images. The process comprises generating the 2D constructed image by combining the tonal triangles taken from the 2D images based on neighbor relationships among the plurality of contour triangles.

The features and advantages of the invention will be more readily understood from the following detailed description which should be read in conjunction with the accompanying drawings.

### BRIEF DESCRIPTION OF THE DRAWINGS

FIG. 1 is a flow diagram showing an example method for generating a 2D constructed image.

FIG. 2A is a plan view showing a device rotating around an object in order to generate tonal data and depth data for the object.

FIG. 2B is an isometric view corresponding to FIG. 2A, showing the device at two positions where the device generates respective 2D images.

FIG. 3 is a schematic diagram showing depth data as a point cloud defined in 3D space.

FIG. 4 is a schematic diagram showing contour triangles that are derived from the point cloud and that model surface contours of the object.

FIG. 5 is a schematic diagram showing a first 2D image generated by the device in FIG. 2B and showing a first image patch, which is a redacted version of the first 2D image.

FIG. 6 is a schematic diagram showing a second 2D image generated by the device in FIG. 2B and showing a second image patch, which is a redacted version of second first 2D image.

FIGS. 7A-7C are schematic diagrams showing how a 2D constructed image is generated without triangles-based merging.

FIG. 8 is a schematic diagram showing how the first and second image patches may be arranged in a texture image.

FIGS. 9A-9C are schematic diagrams showing how a 2D constructed image is generated with triangles-based merging.

FIG. 10 is a schematic diagram showing an example process for triangles-based merging.

FIGS. 11A-11C are isometric views showing how 2D images generated by the device may have different view directions due to yaw, pitch, and roll rotation.

FIG. 12 is a schematic diagram showing how a 2D constructed image is generated with triangles-based merging that includes fixing a corner mismatch.

FIG. 13 is a schematic diagram showing an example system for generating a 2D constructed image.

FIG. 14 shows a mannequin leg having a simulated wound from which a 2D constructed image is generated with a process for triangles-based merging.

FIG. 15 shows a mannequin foot having a simulated wound, from which a 2D constructed image is generated with a process for triangles-based merging that includes fixing corner mismatches.

FIG. 16 shows a mannequin leg having a simulated wound from which a 2D constructed image is generated without a process for triangles-based merging.

### DETAILED DESCRIPTION

As used herein, a 2D image is a planar image that comprises points, each point having its position defined by two position coordinates. All points are located on a common plane (the same plane) according to their two position coordinates. For example, the coordinates may be based on a Cartesian coordinate system or polar coordinate system. For example, a 2D image may be an electronic image comprising pixels having positions defined by two position coordinates along respective orthogonal axes, such as X- and Y-axes. The pixels may be further defined by tonal data, such as grayscale values or color values. All the pixels are located on a common plane (the same plane) according to their respective X-axis coordinate and Y-axis coordinate.

As used herein, “3D space” refers to a real or imaginary volume in which points are located according to three position coordinates. For example, the coordinates may be based on a Cartesian or spherical coordinate system.

Some elements in the figures are labeled using reference numerals with letters (e.g., 40A, 40B, 50A, 50B, etc.) to distinguish particular members within the group of elements.

Reference numerals without letters (e.g., 40 and 50) refer to any or all members of the group.

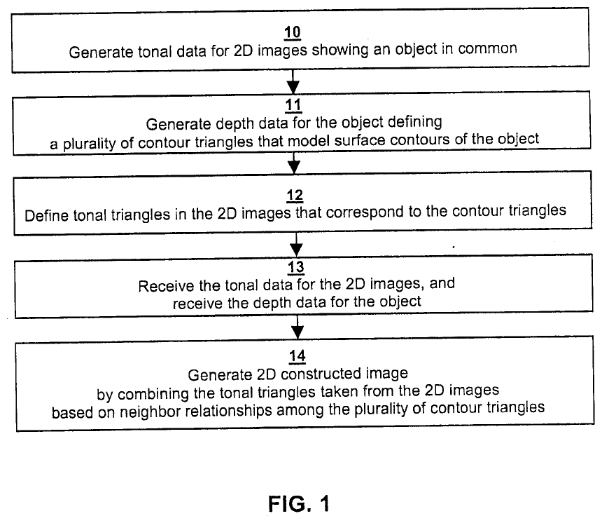

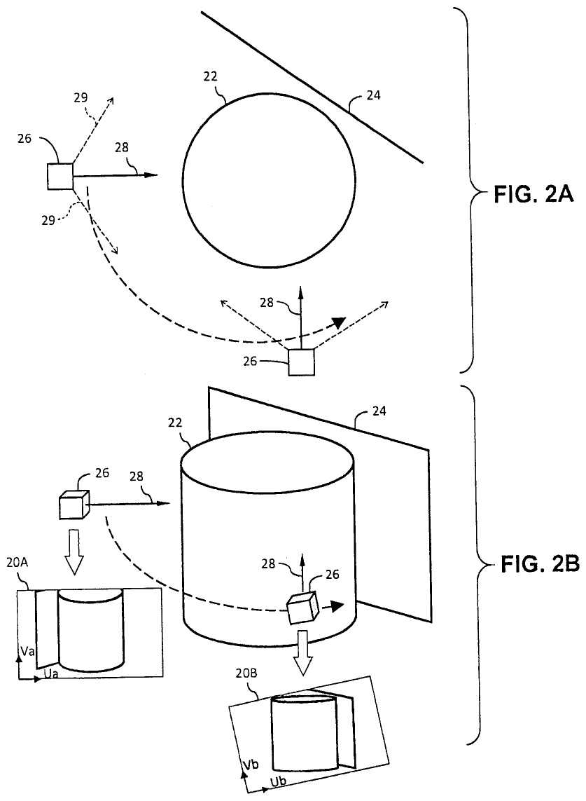

Referring now in more detail to the drawings for purposes of illustrating non-limiting examples, wherein like reference numerals designate corresponding or like elements among the several views, there is shown in FIG. 1 an example method for generating a 2D constructed image. The 2D constructed image is a type of 2D image that is constructed from triangular tiles taken from different 2D images. The triangular tiles are referred to as tonal triangles since they provide color tone and/or shading to the 2D constructed image. FIGS. 2A-8C will be referenced in describing the blocks in FIG. 1. At block 10 (FIG. 1), tonal data for 2D images 20 (FIG. 2B) are generated. 2D images 20 all show object 22 in common. 2D images 20 comprise first 2D image 20A of object 22 and second 2D image 20B of object 22. First 2D image 20A has a view direction that differs from that of second 2D image 20B. Consequently, first 2D image 20A includes a portion of object 22 (e.g., a left side of object 22) that is absent from second 2D image 20B, and second 2D image 20B includes a portion of object 22 (e.g., a right side of object 22) that is absent from first 2D image 20A. In FIG. 2B, the difference in view direction is evident from differing orientations of optical axis 28 of device 26.

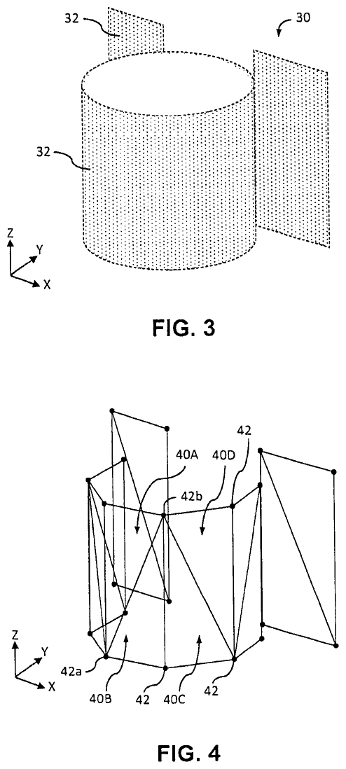

The tonal data comprise grayscale values and/or color values. For example, the tonal data may define pixels in terms of color and/or shading. For example, each pixel is defined in terms of position according to Cartesian coordinates on mutually orthogonal Ua- and Va-axes of first 2D image 20A or Ub- and Vb-axes of second 2D image 20B. The axes are designated U and V so that the 2D coordinate system of the first and second images is not confused with the 3D coordinate system of FIG. 3. 2D images 20 collectively provide a pictorial representation of object 22 based on the tonal data and the 2D position coordinates of the pixels.

For example, object 22 may be a manufactured item (e.g., a ceramic vase) or a naturally occurring item (e.g., a part of the human anatomy). For example, tonal data may define a graphic design that extends around a vase, or may define an injury or wound on a part of the anatomy. 2D images 20 may show other objects 24, referred to as secondary objects, that are not of particular interest. For example, secondary objects 24 may include items in the background (e.g., a tabletop that supports a ceramic vase or bench that supports a part of the anatomy).

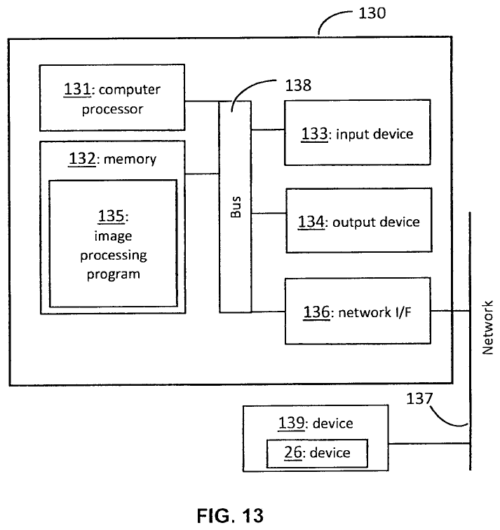

At block 11 (FIG. 1), 3D position data is generated for object 22. The 3D position data is referred to as depth data. The depth data define a plurality of contour triangles that model surface contours of object 22. Each contour triangle has three vertices in 3D space. The contour triangles collectively provide a 3D geometric model of object 22. For example, the contour triangles may model a smooth surface of a vase, or may model an irregular surface of a wound on a part of the anatomy. For example, the depth data may be point cloud data 30 (FIG. 3) comprising a plurality of points 32 having locations defined in 3D space, and from which contour triangles 40 (FIG. 4) are defined by a computer (e.g., computer processor 131 in FIG. 13). For example, each point 32 in point cloud data 30 has a location defined by three Cartesian coordinates corresponding to mutually orthogonal X-, Y-, and Z-axes.

Blocks 10 and 12 may be performed simultaneously by using device 26 (FIGS. 2A and 2B) configured to capture tonal information (e.g., color and/or shading) and range information which gives depth data. Device 26 may comprise CMOS or CCD image sensors. Device 26 may comprise mechanical and other components (e.g., integrated circuits) to sense range via triangulation or Time-of-Flight (ToF). For example, device 26 may have integrated circuits that perform ToF computations. For example, device 26 may comprise a structured-light source known in the art of 3D scanning. For example, device 26 may comprise an RGB-D camera.

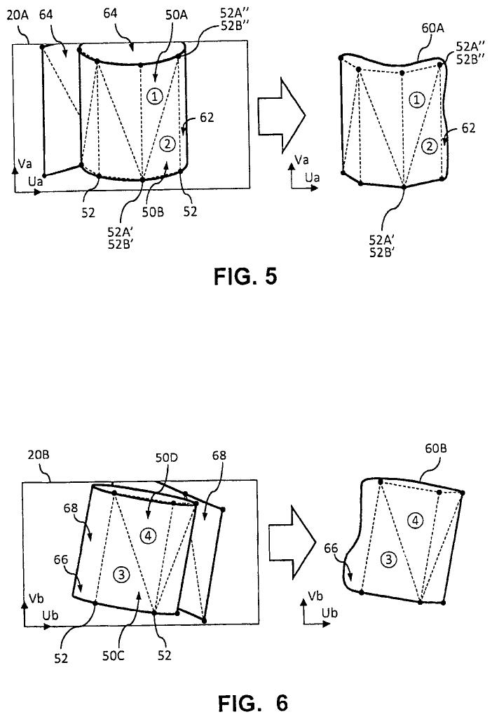

At block 13 (FIG. 1), tonal triangles 50 (FIG. 5) are defined in 2D images 20, where such tonal triangles correspond to contour triangles 40 (FIG. 4). A computer is used to analyze the depth data to define a plurality of contour triangles 40 that model surface contours of object 22. At least some of contour triangles 40 are interconnected, thereby forming a mesh (also referred to as a wireframe) that approximates or models the surface contours of object 22. The computer associates contour triangles 40 with corresponding areas, also in the shape triangles, in 2D images 20. The corresponding areas in 2D images 20 are referred to as tonal triangles 50.

Referring to FIGS. 4 and 5, the computer associates contour triangle 40A with tonal triangle 50A, and contour triangle 40B with tonal triangle 50B. Referring to FIGS. 4 and 6, the computer associates contour triangle 40C with tonal triangle 50C, and contour triangle 40D with tonal triangle 50D.

For example, the computer identifies vertices 42 for each contour triangle 40, and then identifies particular points 52 in 2D images 20 that correspond to vertices 42. Points 52 identified in 2D images 20 serve as corners of the corresponding tonal triangle. In general, any contour triangle 40 is not necessarily the same shape as its corresponding tonal triangle 50. In some instances, a tonal triangle will have a shape (i.e., will have interior angles at the corners) that differ from those of its corresponding contour triangle. The difference in shape may arise from foreshortening due perspective, viewing angle, and/or optics within device 26.

At block 13 (FIG. 1), the tonal data for 2D images 20 are received, and depth data for object 22 are received (e.g., received by apparatus 130 in FIG. 13).

At block 14 (FIG. 1), a 2D constructed image is generated by combining tonal triangles 50 taken from the 2D images based on neighbor relationships among contour triangles 40. As indicated above, the 2D images comprise first 2D image 20A and second 2D image 20B.

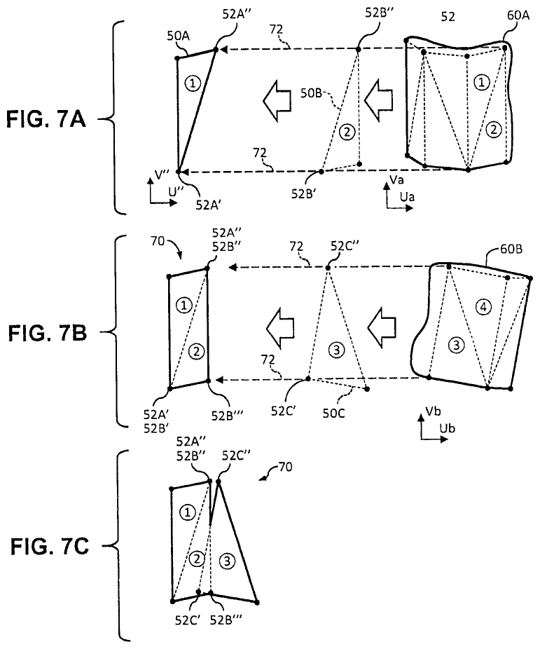

When generating the 2D constructed image, tonal triangles 50 may be derived from first and second 2D images 20A, B. Here, the term “derived” encompasses at least two possible examples. In a first example, tonal triangles 50 are taken from the first and second 2D images 20A, B. In a second example (as shown in FIGS. 7A-9C), tonal triangles 50 are taken from image patches that are redacted or segmented versions of first and second 2D images 20A, B. Image patches are described below in connection with FIGS. 5 and 6.

In FIG. 5, first 2D image 20A is used to generate first image patch 60A, which is another example of a 2D image. First image patch 60A may be generated by a computer (e.g., computer processor 131 in FIG. 13) executing a segmentation algorithm that divides first 2D image 20A into multiple groups. The groups are referred to as image patches. Pixels within a group have one or more characteristics in common. For example, the characteristics may include any of tonal data and associated depth data associated with the pixels. For example, the computer (e.g., computer processor 131 in FIG. 13) may use a combination of tonal data and associated depth data for a particular pixel in first 2D image 20A to determine whether that pixel is to be included in or excluded from first image patch 60A. For example, pixels associated with depth data within a range (e.g., have similar positions in 3D space) may be included in first image patch 60A, while other pixels associated with depth data outside of the range are excluded from first image patch 60A. Additionally or alternatively, pixels having tonal data within a range (e.g., have similar colors or grayscale shading) may be included in first image patch 60A, while other pixels having tonal data outside of the range are excluded from first image patch 60A. Thus, it is possible for first image patch 60A to include portion 62 of the object and to exclude portions 64 of the object and secondary objects.

Likewise in FIG. 6, second 2D image 20B is used to generate second image patch 60A which is another example of a 2D image. Thus, it is possible for second image patch 60B to include portion 66 of the object and to exclude portions 68 of the object and secondary objects.

Referring to FIGS. 5 and 6, note that tonal triangles 50 in FIG. 6 continue from tonal triangles 50 in FIG. 5. Specifically, tonal triangle 50C in FIG. 6 continues from tonal triangle 50B in FIG. 5.

In the figures discussed below, reference numerals 1, 2, 3, and 4 enclosed in circles designate first, second, third, and fourth tonal triangles for clarity and to facilitate discussion. In addition, prime notations (′ and ″ and ′″) are sometimes used to differentiate the three corners of a tonal triangle.

The process at block 14 (FIG. 1) comprises identifying first contour triangle 40A (FIG. 4) from among the plurality of contour triangles 40 defined by depth data 30 (FIG. 3). First contour triangle 40A may be identified randomly. First contour triangle 40A may be identified based on predetermined criteria stored in memory within the system. Alternatively, first contour triangle 40A may be identified based on user input. For example, a user may be interested in capturing a graphic pattern on a vase. Thus, it may be desirable to start the process for generating the 2D constructed image from a central area of the graphic pattern. The user may provide a user input to specify the central area, such as by touching a touch-sensitive display screen that shows a 3D digital model made of contour triangles defined by depth data received at block 13. The user input is used at block 14 to identify first contour triangle 40A.

Next, first tonal triangle 50A (FIG. 5) is identified from among the plurality of tonal triangles 50 in the 2D images. Identification is performed according to first tonal triangle 50A having at least two corners 52 associated with vertices 42 of first contour triangle 40A.

In addition, second contour triangle 40B (FIG. 4) is selected from among the plurality of contour triangles 40 defined by the depth data. Selection is performed according to second contour triangle 40B and the first contour triangle 40A sharing two vertices 42 in common. The sharing of vertices 42 in common establishes a neighbor relationship between first contour triangle 40A and second contour triangle 40B. Another type of neighbor relationship would be for second contour triangle 40B and the first contour triangle 40A to share a side edge in common.

The two vertices in common include first vertex 42a and second vertex 42b (FIG. 4). First vertex 42a has 3D coordinates associated with 2D coordinates of both first corner 52A′ of first tonal triangle 50A (FIG. 5) and first corner 52W of second tonal triangle 50B. Second vertex 42b (FIG. 4) has 3D coordinates associated with 2D coordinates of both second corner 52A″ (FIG. 5) of the first tonal triangle 50A and second corner 52B″ of second tonal triangle 50B.

Next, second tonal triangle 50B (FIG. 5) is identified as corresponding to second contour triangle 40B. Identification is performed according to second tonal triangle 50B having at least two corners 52 associated with vertices 42 of second contour triangle 40B (FIG. 4).

FIGS. 7A and 7B show how second tonal triangle 50B and first tonal triangle 50A are combined such that, in 2D constructed image 70, two of corners 52B′ and 52B″ of second tonal triangle 50B are located respectively at two of corners 52A′ and 52A″ of first tonal triangle 50A. The combining process comprises applying the same linear translation vector 72 to the two of corners 52B′ and 52B″ of second tonal triangle 50B. In addition, third contour triangle 40C (FIG. 4) is selected from among the plurality of contour triangles 40 defined by the depth data. Selection is performed according to third contour triangle 40C and the second contour triangle 40B sharing two vertices 42 in common. The sharing of vertices 42 in common establishes a neighbor relationship between second contour triangle 40B and third contour triangle 40C. Another type of neighbor relationship would be for second contour triangle 40B and the third contour triangle 40C to share a side edge in common.

Next, third tonal triangle 50C (FIG. 6) is identified as corresponding to third contour triangle 40C. Identification is performed according to third tonal triangle 50C having at least two corners 52 associated with vertices 42 of third contour triangle 40C.

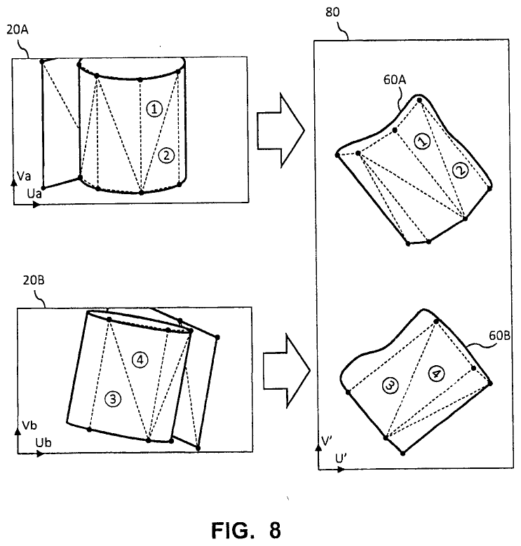

FIGS. 7B and 7C show how third tonal triangle 50C and second tonal triangle 50B are combined. The combining process comprises applying the same linear translation vector 72 to the two of corners 52C′ and 52C″ of third tonal triangle 50B. Note that the coordinate system (Ub- and Vb-axes) of third tonal triangle 50C in second patch image 60B differs from the coordinate system (Ua- and Va-axes) of second tonal triangle 50B in first patch image 60A. The difference in the coordinate systems may, for example, be a consequence of the difference in view direction between first 2D image 20A (the source of second tonal triangle 50B) and second 2D image 20B (the source of third tonal triangle 50C). The difference in the coordinate systems may, for example, be a byproduct of creating first and second image patches 60A, B. The process for creating the image patches may comprise placing the image patches on a single 2D image, referred to as a texture image. As shown in FIG. 8, texture image 80 comprises first and second image patches 60A, B at orientations that are rotated relative to first and second 2D images 20A, B. Rotation may be performed by the segmentation algorithm mentioned previously. Due to the difference in the coordinate systems, applying the same linear translation vector 72 (FIG. 7B) to two of corners 52C′ and 52C″ of third tonal triangle 50C does not result in corners 52C′ and 52C″ being located respectively at corners 52B″′ and 52B″ of second tonal triangle 50B. This mismatch of two corners is undesirable, as it may cause gaps, a bend, or other defect in a pictorial representation within 2D constructed image 70 (e.g., gaps or a bend in a graphic design on a vase).

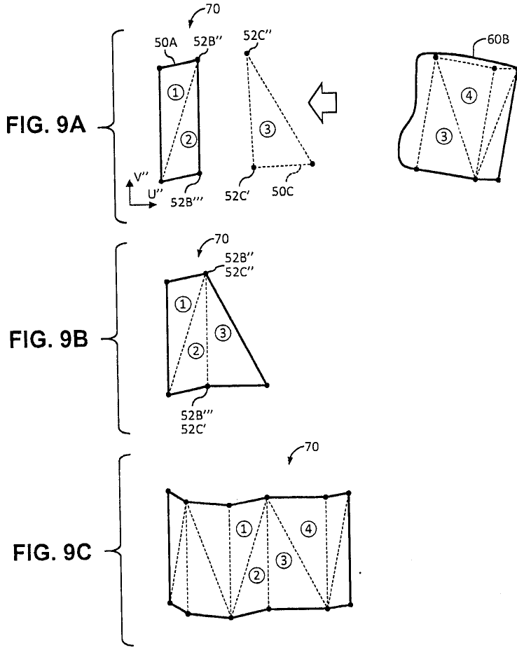

Alternatively, the process for combining tonal triangles may continue as shown in FIGS. 9A-9C to avoid or minimize the defects mentioned above.

FIG. 9A continues from 2D constructed image 70 of FIG. 7B. In FIG. 9A, third contour triangle 40C is selected as in FIG. 7B. In addition, third tonal triangle 50C is identified as corresponding to third contour triangle 40C as in FIG. 7B.

FIGS. 9A and 9B show how third tonal triangle 50C and second tonal triangle 50B are combined such that, in 2D constructed image 70, two of corners 52C′ and 52C″ of third tonal triangle 50C are located respectively at two of corners 52B′″ and 52B″ of second tonal triangle 50B. The combining process does not apply the same linear translation vectors to the two of corners 52C′ and 52C″ of third tonal triangle 50C. The combining process applied here is called triangles-based merging. Triangles-based merging allows tonal triangles to be combined without changing the interior corner angles of the tonal triangles.

In FIGS. 9A and 9B, tonal triangles were taken from different 2D images to generate 2D constructed image 70. In particular, the second tonal triangle (which can be a first tonal triangle in another example) is taken from the first image patch 60A (an example of a first 2D image). The third tonal triangle (which can be a second tonal triangle in another example) is derived from the second image patch 60B (an example of a second 2D image).

FIG. 9C shows 2D constructed image 70 after additional tonal triangles 50 are taken first and second image patches 60A, B and combined by triangles-based merging.

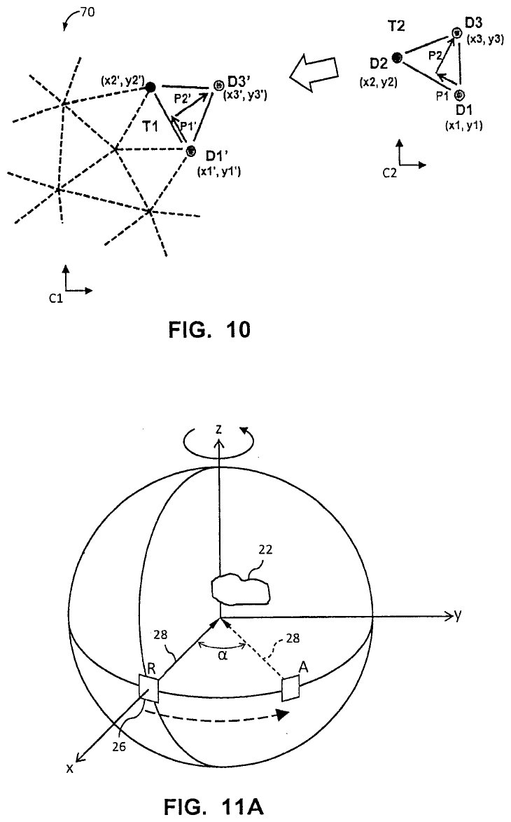

FIG. 10 illustrates an example of triangles-based merging. In this example, triangle T2 is combined with triangle T1 by transferring T2 from its native coordinate system C2 (e.g., Ua & Va in FIG. 5, or Ub & Vb in FIG. 6, or U′ & V′ in FIG. 8) to the coordinate system C1 (e.g., V″ & U″ in FIGS. 7A and 9A) of T1. This is accomplished by merging common edges D1-D2 and D1′-D2′, which involves finding new 2D coordinates for corner D3, i.e., finding 2D coordinates for D3′. Since vectors P preserve relative positions, 2D coordinates for D3′ may be found using the following equation:

D′₃=D′₁+\vec{P′}₁+\vec{P′}₂ Eqn. 1
where:

D′₃=(x′₃, y′₃)

D′₁=(x′₁, y′₁)

To preserves triangle shape and area, the interior angles at the corners, base length, and height are kept the same for triangle T2 as it is transferred to coordinate C1. This is accomplished with the following vector relationships:

|\vec{P′₁}|=|\vec{P₁}| and |\vec{P′₂}|32 |\vec{P₂}|

The above vector relationships allow for the derivation of the following equations to find 2D coordinates for D3′ based on Eqn. 1.

$$\begin{matrix}\vec{{P}_{1}^{′}} = \vert \vec{{D}_{3} {D}_{1}} \cdot \frac{\vec{{D}_{2} {D}_{1}}}{\vert \vec{{D}_{2} {D}_{1}} \vert} \vert \cdot \frac{\vec{{D}_{1}^{′} {D}_{2}^{′}}}{\vert {D}_{1}^{′} {D}_{2}^{′} \vert} & Eqn . 2 \\ \vec{{P}_{2}^{′}} = \vert \vec{{D}_{3} {D}_{1}} \times \frac{\vec{{D}_{2} {D}_{1}}}{\vert \vec{{D}_{2} {D}_{1}} \vert} \vert . \vec{{n}_{1}} & Eqn . 3 \\ \vec{{n}_{1}} \cdot \frac{\vec{{D}_{1}^{′} {D}_{2}^{′}}}{\vert {D}_{1}^{′} {D}_{2}^{′} \vert} = 0 & Eqn . 4\end{matrix}$$

The inventors have found that the use of neighbor relationships among the plurality of contour triangles in combination with triangles-based merging provides particularly good results even when 2D images 20 have different view directions.

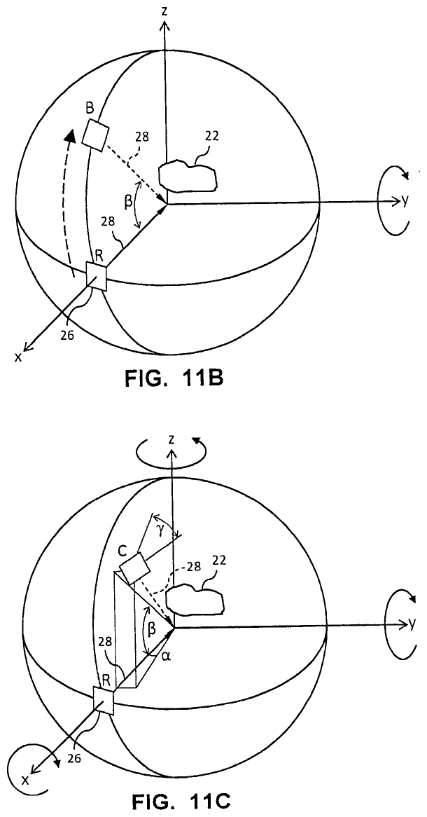

FIGS. 11A-11C illustrate how first 2D image 20A can have a view direction that differs from that of second 2D image 20B. Device 26 is illustrated with its optical axis 28, which corresponds to the view direction of device 26. Optical axis 28 may be defined as being the center of the field of view of device 26. Field of view 29 (FIG. 2A) is what allows device 26 to capture tonal data, such as grayscale and/or color values, and thereby provide 2D images 20. Optical axis 28 may be defined as a straight line along which there is rotational symmetry in an optical system of device 26. The optical system is used to capture tonal data. Optical axis 28 may pass through the geometric center of an optical lens of device 26.

In FIGS. 11A-11C, device 26 starts at position R and is then moved through 3D space while device 26 generates 2D images 20 of object 22. A coordinate system is shown with mutually orthogonal x-, y-, z-axes. In these figures, the x-axis is coincident with optical axis 28 of device 26 at position R. In the descriptions below, position R will be a point of reference in explaining differences in view direction. Thus, position R will be referred to as reference position R.

In FIG. 11A, device 26 is rotated about the z-axis (a vertical axis) when moving from reference position R to position A. The view direction represented by optical axis 28 at position A is not parallel to view direction represented by optical axis 28 at reference position R. In particular, there is a non-zero yaw angle α between optical axis 28 at reference position R and optical axis 28 at position A. As used herein, “yaw angle” refers to rotation about a vertical axis perpendicular to optical axis 28 at reference position R.

In FIG. 11B, device 26 is rotated about the y-axis (a horizontal axis) when moving from reference position R to position B. The view direction represented by optical axis 28 at position B is not parallel to view direction represented by optical axis 28 at reference position R. In particular, there is a non-zero pitch angle β between optical axis 28 at reference position R and optical axis 28 at position B. As used herein, “pitch angle” refers to rotation about a horizontal axis perpendicular to optical axis 28 at reference position R.

In FIG. 11C, device 26 is rotated about the x-, y-, and z-axes when moving from reference position R to position C. The view direction represented by optical axis 28 at position C is not parallel to view direction represented by optical axis 28 at reference position R. In particular, there are non-zero angles α and β and a non-zero roll angle γ between optical axis 28 at reference position R and optical axis 28 at position C. As used herein, “roll angle” refers to rotation about optical axis 28. The roll angle corresponds to a twisting motion of device 26 about its optical axis 28.

In combination with any of the rotations discussed above, device 26 may also be moved linearly from reference position R. For example, motion of device 26 may have one or more linear translation components (e.g., movement parallel to the x-, y-, and/or z-axis) combined with one or more rotation components (e.g., a non-zero α, β, and/or γ angle).

Referring again to FIG. 2B, the tilt of 2D image 20B relative to 2D image 20A is a result of a non-zero roll angle γ (twisting motion). Conventional image stitching processes, such as those used to generate panoramic images, often perform poorly when a twisting motion is applied to the camera.

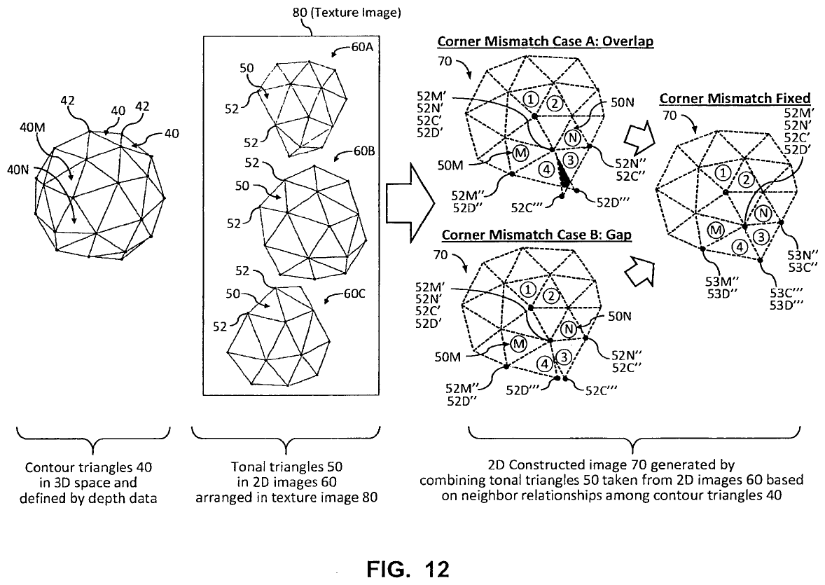

FIG. 12 illustrates another example 2D constructed image 70 that is generated using neighbor relationships among the plurality of contour triangles in combination with triangles-based merging. In 2D constructed image 70, the first and second tonal triangles have been combined by taking tonal triangles from one of the 2D images 60 shown in FIG. 12. Other tonal triangles (Nth, Mth, third, and fourth) are combined into 2D constructed image 70 by taking those tonal triangles from the 2D images 60 shown in FIG. 12. The terms Nth and Mth are used to refer to arbitrary triangles. In addition, the terms first, second, third, fourth, and the like are used to differentiate individual triangles and do not necessarily dictate a sequential order of processing. For instance, an Nth tonal triangle may combined into 2D constructed image 70 after a so-called second tonal triangle but before a so-called third tonal triangle. In addition, reference signs 1, 2, 3, 4, N, and M enclosed in circles designate first, second, third, fourth, Nth, and Mth tonal triangles for clarity and to facilitate discussion.

A process of adding a third tonal triangle to 2D constructed image 70 is as follows. A third contour triangle (one of the triangles at the far left side of FIG. 12) is selected from among the plurality of contour triangles 40 defined by the depth data. Selection is performed according to the third contour triangle and an Nth contour triangle 40N sharing two vertices 42 in common. Note that Nth contour triangle 40N (another one of the triangles at the far left side of FIG. 12) corresponds to Nth tonal triangle 50N that is already connected (via intervening tonal triangles) to the first tonal triangle in 2D constructed image 70. Next, a third tonal triangle (one of the triangles within texture image 80) is identified as corresponding to the third contour triangle. The identification is performed according to the third tonal triangle having at least two corners 52 associated with vertices 42 of the third contour triangle. Next, the third tonal triangle and the Nth tonal triangle 50N are combined such that, in 2D constructed image 70, first and second corners 52C′ and 52C″ of the third tonal triangle are located respectively at first and second corners 52N′ and 52N″ of Nth tonal triangle 50N.

A process of adding a fourth tonal triangle to 2D constructed image 70 is as follows. A fourth contour triangle (one of the triangles at the far left side of FIG. 12) is selected from among the plurality of contour triangles 40 defined by the depth data. Selection is performed according to the fourth contour triangle and Mth contour triangle 40M (another one of the triangles at the far left side of FIG. 12) sharing two vertices 42 in common. Note that Mth contour triangle 40M corresponds to Mth tonal triangle 50M that is already connected (via intervening tonal triangles) to the first tonal triangle in 2D constructed image 70. Next, a fourth tonal triangle (one of the triangles within texture image 80) is identified as corresponding to the fourth contour triangle. The identification is performed according to the fourth tonal triangle having at least two corners 52 associated with vertices 42 of the fourth contour triangle. Next, the fourth tonal triangle and Mth tonal triangle 50N are combined such that, in 2D constructed image 70, first and second corners 52D′ and 52D″ of the fourth tonal triangle are located respectively at first and second corners 52M′ and 52M″ of Mth tonal triangle 50M.

The third tonal triangle has third corner 52C″′, and the fourth tonal triangles has third corner 52D″′. Notice that third corner 52C′″ is not located at third corner 52D″′. In this example, these corners should coincide based on a neighbor relationship between corresponding third and fourth contour triangles. This is referred to as a corner mismatch. Case A shows a situation in which two adjacent tonal triangles (third and fourth tonal triangles) overlap with each other after having been added to constructed image 70. The overlapping area is darkened for clarity. Case B shows an alternative situation in which two adjacent tonal triangles (third and fourth tonal triangles) have a gap or have sides that fail to coincide after the third and fourth tonal triangles have been added to constructed image 70.

A process for fixing the corner mismatch comprises computing new coordinates for the corners that should coincide. New coordinates are designated by numeral 53. For example, new coordinates 53C″′ and 53D″′ can be the mean values of the original coordinates 52C″′ and 52D″′ With the new coordinates, the third corners of the third and fourth tonal triangles are moved to new positions, which results in displacement of the side edges of the third and fourth tonal triangles. As part of fixing the corner mismatch, the displacement is distributed along the outer perimeter of 2D constructed image 70 so that subsequent tonal triangles can be properly combined onto the third and fourth tonal triangles. The process of distributing the displacement is referred to herein as mesh smoothing. Mesh smoothing has the effect of distributing the displacement only along the outer perimeter of 2D constructed image 70. Mesh smoothing comprises computing new coordinates 53C″ and 53N″ to be shared in common by the third tonal triangle and Nth tonal triangle 50N. Note that 53C″ and 53N″ are at the perimeter of 2D constructed image 70. Mesh smoothing further comprises computing new coordinates 53D″ and 53M″ to be shared in common by the fourth tonal triangle and Mth tonal triangle 50M. Note that 53D″ and 53M″ are at the perimeter of 2D constructed image 70. Coordinates for corners that are not on the perimeter are unchanged by mesh smoothing. For instance, coordinates for first corners 52M′, 52N′, 52C′, and 52D′ are unchanged by mesh smoothing.

FIG. 13 shows an example system comprising apparatus 130 configured to perform the methods and processes described herein. Apparatus 130 can be a server, computer workstation, personal computer, laptop computer, tablet, or other type of machine that includes one or more computer processors and memory. Apparatus further comprises external device 139. Device 139 may include device 26, which is used to capture tonal information and range information as previously discussed.

Apparatus 130 includes one or more computer processors 131 (e.g., CPUs), one or more computer memory devices 132, one or more input devices 133, and one or more output devices 134. The one or more computer processors 131 are collectively referred to as processor 131. Processor 131 is configured to execute instructions. Processor 131 may include integrated circuits that execute the instructions. The instructions may embody one or more software modules for performing the processes described herein. The one of more software modules are collectively referred to as image processing program 135.

The one or more computer memory devices 132 are collectively referred to as memory 132. Memory 132 includes any one or a combination of random-access memory (RAM) modules, read-only memory (ROM) modules, and other electronic devices. Memory 132 may include mass storage device such as optical drives, magnetic drives, solid-state flash drives, and other data storage devices. Memory 132 includes a non-transitory computer readable medium that stores image processing program 135.

The one or more input devices 133 are collectively referred to as input device 133. Input device 133 can allow a person (user) to enter data and interact with apparatus 130. For example, identification of the first contour triangle may be based on user input via input device 133. Input device 133 may include any one or more of a keyboard with buttons, touch-sensitive screen, mouse, electronic pen, microphone, and other types of devices that can allow the user provide a user input to the system.

For example, the user may be interested in generating a 2D constructed image of a wound or injury on a part of a human anatomy, so the user may input a command via input device 133 to specify a central area of interest (e.g., a central area of the wound) shown in a 3D digital model made of a plurality of contour triangles in 3D space defined by depth data. Processor 131 identifies a first contour triangle, from among the plurality of contour triangles, which corresponds to the central area of interest. Thereafter, processor 131 proceeds to generate a 2D constructed image as described for block 14 (FIG. 1).

The one or more output devices 134 are collectively referred to as output device 134. Output device 134 may include a liquid crystal display, projector, or other type of visual display device. Output device 134 may be used to display a 3D digital model to allow the user to specify a central area of interest. Output device 134 may be used to display a 2D constructed image. Output device 134 may include a printer that prints a copy of a 2D constructed image.

Apparatus 130 includes network interface (I/F) 136 configured to allow apparatus 130 to communicate with device 139 through network 137, such as a local area network (LAN), a wide area network (WAN), the Internet, and telephone communication carriers. Network I/F 136 may include circuitry enabling analog or digital communication through network 137. For example, network I/F 136 may be configured to receive any of tonal data and depth data from device 139 at block 13 (FIG. 1). For example, device 139 may include device 26 in order to generate the tonal data and depth data at blocks 10 and 11 (FIG. 1). Network FF 136 may be configured to transmit a 2D constructed image to device 139. The above-described components of apparatus 130 are communicatively coupled to each other through communication bus 138.

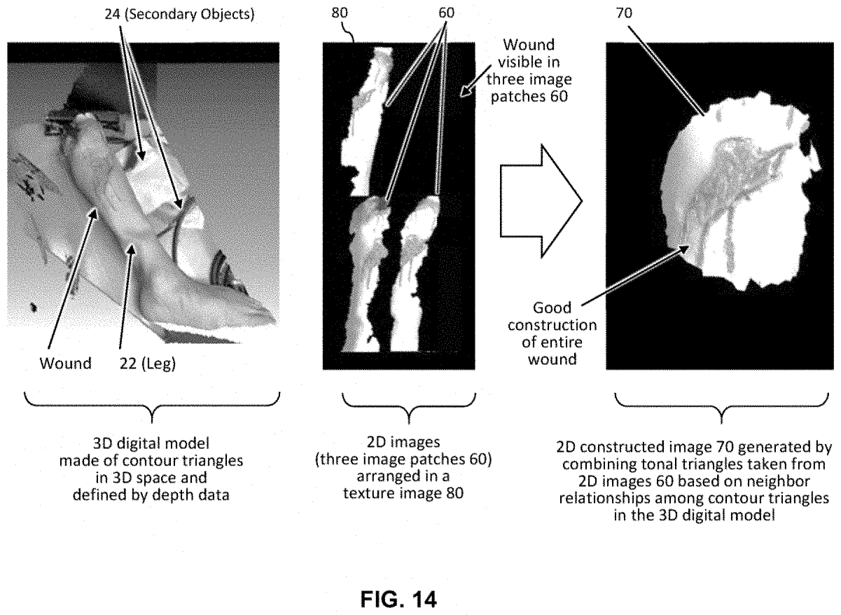

FIGS. 14-16 show results from tests performed by the inventors. The results show the effectiveness of triangles-based merging.

In FIG. 14, the subject area is a simulated wound on a mannequin leg. Due to curvature of the subject area, the entire wound would not be visible from a single snapshot image from a conventional camera. An RGB-D camera was rotated around the mannequin leg to generate tonal data and depth data for the mannequin leg. Next, a computer, executing a segmentation algorithm, was used to generate texture image 80 that includes image patches 60 corresponding to the rear, right, and front views of the leg. Image patches 60 show the wound from different view directions. The computer performed triangles-based merging to generate 2D constructed image 70 that shows the entire wound.

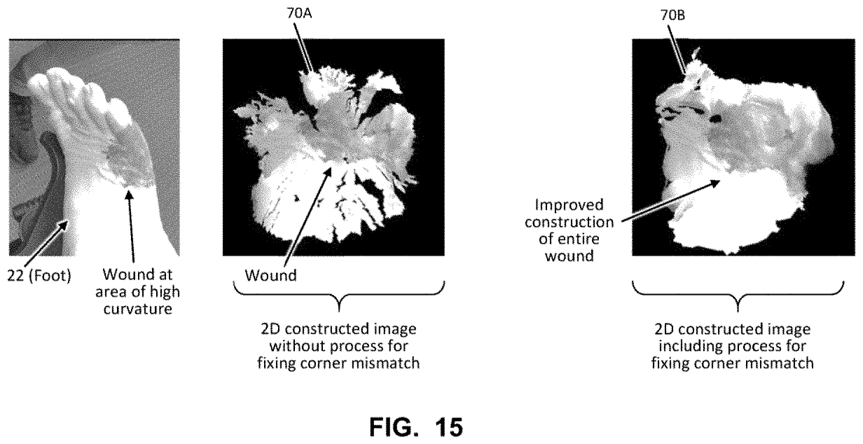

In FIG. 15, the subject area is a simulated wound that extends around the edge of a mannequin foot. Due to curvature of the subject area, the entire wound would not be visible from a single snapshot image from a conventional camera. An RGB-D camera was rotated around the mannequin foot to generate tonal data and depth data for the mannequin foot. In one test run, a computer performed triangles-based merging to generate 2D constructed image 70A. Due to the high curvature of the subject area, there are many gaps and disconnected regions in 2D constructed image 70A. In another test run, the computer performed triangles-based merging that included fixing corner mismatches to generate 2D constructed image 70B. By fixing corner mismatches, a significant reduction in gaps and disconnected regions was achieved in 2D constructed image 70B.

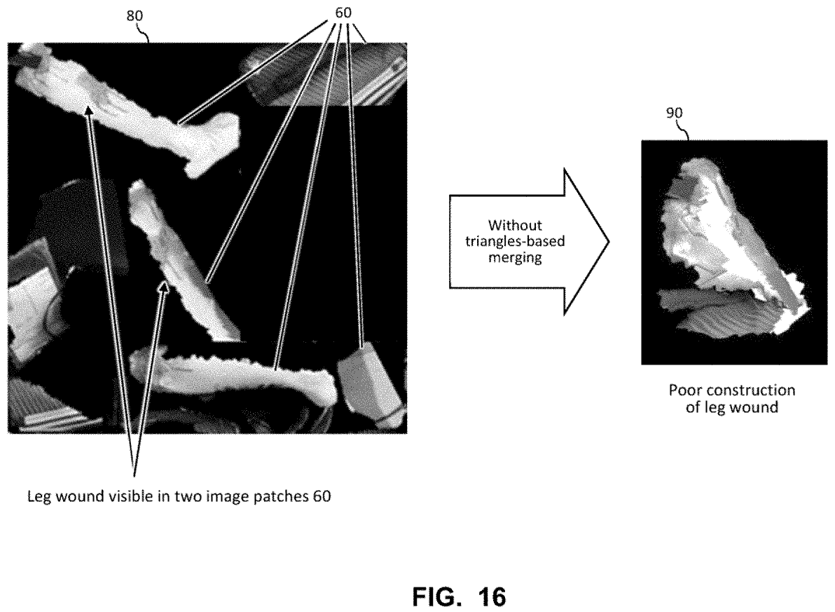

In FIG. 16, the subject area is a simulated wound on a mannequin leg. An RGB-D camera was used to generate tonal data and depth data for the mannequin leg. Next, a computer, executing a segmentation algorithm, was used to generate texture image 80 that includes image patches 60 of the leg and secondary objects near the leg. Three of the image patches 60 show the wound from different view directions. The computer did not use triangles-based merging to generate 2D constructed image 90. As a result, the wound appears incoherent and garbled in 2D constructed image 90.

From the descriptions above, it will be appreciated that the method and system described herein are capable of generating a 2D constructed image that appears natural. As compared to conventional processes for stitching and montaging, the process generates a 2D constructed image that is a more accurate presentation of the true area, shape, and/or size of the subject.

While several particular forms of the invention have been illustrated and described, it will also be apparent that various modifications may be made without departing from the scope of the invention. It is also contemplated that various combinations or subcombinations of the specific features and aspects of the disclosed embodiments may be combined with or substituted for one another in order to form varying modes of the invention. Accordingly, it is not intended that the invention be limited, except as by the appended claims.

1. A method for generating a 2D constructed image, the method comprising:
receiving tonal data for 2D images all showing an object in common, the tonal data comprising one of grayscale values or color values;
receiving depth data for the object, the depth data defining a plurality of contour triangles that model surface contours of the object, each contour triangle having three vertices in 3D space, the plurality of contour triangles corresponding to a plurality of tonal triangles, comprising the tonal data, in the 2D images; and
generating the 2D constructed image by combining the tonal triangles taken from the 2D images based on neighbor relationships among the plurality of contour triangles.

2. The method of claim 1, wherein the 2D images comprise a first 2D image and a second 2D image, the first 2D image being a first view of the object taken along a first view direction, the second 2D image being a second view of the object taken along a second view direction, and there is one or more of a non-zero pitch angle, a non-zero yaw angle, and a non-zero roll angle between the first view direction and the second view direction.

3. The method of claim 1, wherein the generating of the 2D constructed image comprises:
identifying a first contour triangle from among the plurality of contour triangles defined by the depth data;
identifying a first tonal triangle from among the plurality of tonal triangles in the 2D images, the identifying performed according to the first tonal triangle having at least two corners associated with vertices of the first contour triangle;
selecting a second contour triangle from among the plurality of contour triangles defined by the depth data, the selecting performed according to the second contour triangle and the first contour triangle sharing two vertices in common;
identifying a second tonal triangle that corresponds to the second contour triangle, the identifying performed according to the second tonal triangle having at least two corners associated with vertices of the second contour triangle; and
combining the second tonal triangle and the first tonal triangle such that, in the 2D constructed image, two corners of the second tonal triangle are located respectively at two corners of the first tonal triangle.

4. The method of claim 3, wherein, the identifying of the first contour triangle is based on user input that specifies a location on the object that corresponds to the first contour triangle.

5. The method of claim 3, wherein, for the second contour triangle and the first contour triangle, the two vertices in common include a first vertex and a second vertex, the first vertex has 3D coordinates associated with 2D coordinates of both a first corner of the first tonal triangle and a first corner of the second tonal triangle, and the second vertex has 3D coordinates associated with 2D coordinates of both a second corner of the first tonal triangle and a second corner of the second tonal triangle.

6. The method of claim 3, wherein the 2D images comprise a first 2D image and a second 2D image, the first tonal triangle is derived from the first 2D image when generating the 2D constructed image, the second tonal triangle is derived from the second 2D image when generating the 2D constructed image, the first 2D image being a first view of the object taken along a first view direction, the second 2D image being a second view of the object taken along a second view direction, and there is one or more of a non-zero pitch angle, a non-zero yaw angle, and a non-zero roll angle between the first view direction and the second view direction.

7. The method of claim 6, wherein the first 2D image is a first image patch that includes a portion of the object that is absent from the second 2D image, and the second 2D image is a second image patch that includes a portion of the object that is absent from the first 2D image.

8. The method of claim 3, wherein the generating of the 2D constructed image comprises:
selecting a third contour triangle from among the plurality of contour triangles defined by the depth data, the selecting performed according to the third contour triangle and an Nth contour triangle sharing two vertices in common, the Nth contour triangle corresponding to an Nth tonal triangle connected to the first tonal triangle in the 2D constructed image;
identifying a third tonal triangle that corresponds to the third contour triangle, the identifying performed according to the third tonal triangle having at least two corners associated with vertices of the third contour triangle;
combining the third tonal triangle and the Nth tonal triangle such that, in the 2D constructed image, first and second corners of the third tonal triangle are located respectively at first and second corners of the Nth tonal triangle.

9. The method claim 8, wherein the generating of the 2D constructed image comprises:
selecting a fourth contour triangle from among the plurality of contour triangles defined by the depth data, the selecting performed according to the fourth contour triangle and an Mth contour triangle sharing two vertices in common, the Mth contour triangle corresponding to an Mth tonal triangle connected to the first tonal triangle in the 2D constructed image;
identifying a fourth tonal triangle that corresponds to the fourth contour triangle, the identifying performed according to the fourth tonal triangle having at least two corners associated with vertices of the fourth contour triangle;
combining the fourth tonal triangle and the Mth tonal triangle such that, in the 2D constructed image, first and second corners of the fourth tonal triangle are located respectively at first and second corners of the Mth tonal triangle; and
fixing a corner mismatch in which a third corner of the fourth tonal triangle is not located at a third corner of the third tonal triangle, the fixing comprising
computing a new third corner to be shared in common by the fourth tonal triangle and the third tonal triangle,
computing a new second corner to be shared in common by the fourth tonal triangle and the Mth tonal triangle, and
computing a new second corner to be shared in common by the third tonal triangle and Nth second tonal triangle.

10. The method of claim 1, wherein the combining of the tonal triangles taken from the 2D images comprises combining two or more of the tonal triangles without changing any interior corner angle of the two or more of the tonal triangles.

11. A system for generating a 2D constructed image, the system comprising:
a processor; and
a memory in communication with the processor, the memory storing instructions, wherein the processor is configured to perform a process according to the stored instructions, the process comprising:
receiving tonal data for 2D images all showing an object in common, the tonal data comprising one of grayscale values or color values;
receiving depth data for the object, the depth data defining a plurality of contour triangles that model surface contours of the object, each contour triangle having three vertices in 3D space, the plurality of contour triangles corresponding to a plurality of tonal triangles, comprising the tonal data, in the 2D images; and
generating the 2D constructed image by combining the tonal triangles taken from the 2D images based on neighbor relationships among the plurality of contour triangles.

12. The system of claim 11, wherein in the process that the processor is configured to perform according to the stored instructions, the 2D image comprises a first 2D image and a second 2D image, the first 2D image being a first view of the object taken along a first view direction, the second 2D image being a second view of the object taken along a second view direction, and there is one or more of a non-zero pitch angle, a non-zero yaw angle, and a non-zero roll angle between the first view direction and the second view direction.

13. The system of claim 11, wherein in the process that the processor is configured to perform according to the stored instruction, the generating of the 2D constructed image comprises:
identifying a first contour triangle from among the plurality of contour triangles defined by the depth data;
identifying a first tonal triangle from among the plurality of tonal triangles in the 2D images, the identifying performed according to the first tonal triangle having at least two corners associated with vertices of the first contour triangle;
selecting a second contour triangle from among the plurality of contour triangles defined by the depth data, the selecting performed according to the second contour triangle and the first contour triangle sharing two vertices in common;
identifying a second tonal triangle that corresponds to the second contour triangle, the identifying performed according to the second tonal triangle having at least two corners associated with vertices of the second contour triangle; and
combining the second tonal triangle and the first tonal triangle such that, in the 2D constructed image, two corners of the second tonal triangle are located respectively at two corners of the first tonal triangle.

14. The system of claim 13, wherein in the process that the processor is configured to perform according to the stored instructions, the identifying of the first contour triangle is based on user input that specifies a location on the object that corresponds to the first contour triangle.

15. The system of claim 13, wherein in the process that the processor is configured to perform according to the stored instructions, relative to the second contour triangle and the first contour triangle, the two vertices in common include a first vertex and a second vertex, the first vertex has 3D coordinates associated with 2D coordinates of both a first corner of the first tonal triangle and a first corner of the second tonal triangle, and the second vertex has 3D coordinates associated with 2D coordinates of both a second corner of the first tonal triangle and a second corner of the second tonal triangle.

16. The system of claim 13, wherein in the process that the processor is configured to perform according to the stored instructions, the 2D image comprises a first 2D image and a second 2D image, the first tonal triangle is derived from the first 2D image when generating the 2D constructed image, the second tonal triangle is derived from the second 2D image when generating the 2D constructed image, the first 2D image being a first view of the object taken along a first view direction, the second 2D image being a second view of the object taken along a second view direction, and there is one or more of a non-zero pitch angle, a non-zero yaw angle, and a non-zero roll angle between the first view direction and the second view direction.

17. The system of claim 16, wherein in the process that the processor is configured to perform according to the stored instructions, the first 2D image is a first image patch that includes a portion of the object that is absent from the second 2D image, and the second 2D image is a second image patch that includes a portion of the object that is absent from the first 2D image.

18. The system of claim 13, wherein in the process that the processor is configured to perform according to the stored instructions, the generating of the 2D constructed image comprises:
selecting a third contour triangle from among the plurality of contour triangles defined by the depth data, the selecting performed according to the third contour triangle and an Nth contour triangle sharing two vertices in common, the Nth contour triangle corresponding to an Nth tonal triangle connected to the first tonal triangle in the 2D constructed image;
identifying a third tonal triangle that corresponds to the third contour triangle, the identifying performed according to the third tonal triangle having at least two corners associated with vertices of the third contour triangle;
combining the third tonal triangle and the Nth tonal triangle such that, in the 2D constructed image, first and second corners of the third tonal triangle are located respectively at first and second corners of the Nth tonal triangle.

19. The system of claim 18, wherein in the process that the processor is configured to perform according to the stored instructions, the generating of the 2D constructed image comprises:
selecting a fourth contour triangle from among the plurality of contour triangles defined by the depth data, the selecting performed according to the fourth contour triangle and an Mth contour triangle sharing two vertices in common, the Mth contour triangle corresponding to an Mth tonal triangle connected to the first tonal triangle in the 2D constructed image;
identifying a fourth tonal triangle that corresponds to the fourth contour triangle, the identifying performed according to the fourth tonal triangle having at least two corners associated with vertices of the fourth contour triangle;
combining the fourth tonal triangle and the Mth tonal triangle such that, in the 2D constructed image, first and second corners of the fourth tonal triangle are located respectively at first and second corners of the Mth tonal triangle; and
fixing a corner mismatch in which a third corner of the fourth tonal triangle is not located at a third corner of the third tonal triangle, the fixing comprising
computing a new third corner to be shared in common by the fourth tonal triangle and the third tonal triangle,
computing a new second corner to be shared in common by the fourth tonal triangle and the Mth tonal triangle, and
computing a new second corner to be shared in common by the third tonal triangle and Nth second tonal triangle.

20. The system of claim 11, wherein in the process that the processor is configured to perform according to the stored instructions, the combining of the tonal triangles taken from the 2D images comprises combining two or more of the tonal triangles without changing any interior corner angle of the two or more of the tonal triangles.
